(19) United States
(12) Patent Application Publication
(10) Pub. No.: US 2012/0330881 A1
(43) Pub. Date: Dec. 27, 2012

(54) Evaluation of Next Actions by Customers

(76) Inventors: Zainab Jamal, Palo Alto, CA (US); Hsiu-Khuern Tang, San Jose, CA (US)

(21) Appl. No.: 13/581,602

(22) PCT Filed: Mar. 8, 2010
(86) PCT No.: PCT/US2010/026487

§ 371 Date: Aug. 28, 2012

(51) Int. Cl. G06N 5/02

(52) U.S. Cl. 706/52

(57) ABSTRACT

System, including method, apparatus, and computer-readable storage media, for evaluating probabilities of next actions by customers to permit selective customer targeting. Customer data (20) may be received (32). The customer data (20) may represent a plurality of actions (14) taken by customers (12). At least a portion of the customer data (20) may be transformed (34) according to action number into stratified data (80) including strata, with each of the strata representing actions for one or more action numbers (74). A conditional proportional hazard function (84) may be estimated (36) from a stratum of the stratified data (80). Likelihoods of a next action may be calculated (38) using the hazard functions. The likelihoods may be the likelihoods of a next action at one or more times by individual customers (12) whose latest action has an action number for which the stratum represents actions.

### BACKGROUND

Computers are being exploited increasingly to enable commerce between firms (e.g., businesses) and their customers. For example, many customer transactions are performed via communication with one or more websites of a firm. In any event, since customers often are identified uniquely in computer-logged activities, customer transactions with a firm can be stored as data for analysis. The activities of individual customers can be mined to provide information about customer behavior.

Customers can engage in commerce with a firm in a contractual or non-contractual setting. In a contractual setting, the firm may provide goods/services under an agreement that is maintained and/or renewed explicitly or implicitly over time and that is terminated expressly. For example, the firm may provide cable television service to customers via a monthly contract that can be terminated by each customer at the end of any month. As another example, the firm may be a bank that provides banking services to account holders that entrust the bank with their money and that remain customers as long as some of the money remains with the bank. Accordingly, commerce performed in a contractual setting allows a firm to observe when customers become inactive, which is referred to as customer “churning.” Thus, a firm in a contractual setting can identify its active customer base with accuracy. In contrast, in a non-contractual setting, a firm may provide goods/services on demand, without any agreement about whether or not a customer will remain active with the firm.

Distinguishing active customers from inactive ones in a non-contractual setting can be problematic. Customers that are still active, but have not exhibited recent activity, cannot be distinguished unambiguously from those that have churned. Thus, in a non-contractual setting, customers often are deemed as active or inactive based on an approach using an arbitrary measure of activity, such as whether or not a customer has performed a transaction with the firm within a given period of time, such as one year. However, this approach is inaccurate and reactive, instead of proactive.

### BRIEF DESCRIPTION OF THE DRAWINGS

FIG. 1 is a schematic view of an example system for evaluating probabilities of next actions by customers in a non-contractual setting, in which customer actions taken with a firm are represented with respect to time, in accordance with an embodiment of the invention.

FIG. 2 is a flowchart illustrating steps that may be performed by the example system of FIG. 1 in an example method of evaluating probabilities of next actions by customers in a non-contractual setting, in accordance with an embodiment of the invention.

FIG. 3 is a graph that plots an example baseline hazard function, which may be estimated from a stratum of customer data in the method of FIG. 2, in accordance with an embodiment of the invention.

FIG. 4 is a graph that plots a proportionally adjusted example version of the hazard function of FIG. 3 produced using attribute values for a particular customer, in accordance with an embodiment of the invention.

FIG. 5 is a schematic view of selected aspects of a computer present in the example system of FIG. 1 and configured to perform the example method of FIG. 2, in accordance with an example embodiment of the invention.

### DETAILED DESCRIPTION

The present disclosure provides a system, including method, apparatus, and computer-readable media, for evaluating probabilities of next actions by customers with a firm, such as in a non-contractual setting. A conditional proportional hazard model for repeated events may be used to compute a probability measure of a next action for an individual customer, conditional on the customer's previous action (i.e., last action). Using information regarding the action number of the last action of the customer, the date of the last action, attribute values of the customer on the date of the customer's last action, as well as weights of the attributes for a data stratum that represents actions for the action number of the customer's last action, the likelihood of the customer's next action at different time points from the last action date can be calculated. The system may, for example, allow the firm to identify when each customer is likely to have a next action (e.g., in the next few hours, days weeks, etc.), which may permit the firm to prepare more effective retention and loyalty program for customers and ensure the experience of customers is enhanced. The system also may be expanded to incorporate a method for predicting any given next action by a customer.

A method of evaluating probabilities of next actions by customers is provided to permit selective customer targeting. Customer data may be received. The customer data may represent a plurality of actions taken by customers with respect to a firm, such as in a non-contractual setting. Each action may be assigned an action number according to when the action was taken by a customer, relative to other actions taken by that customer. At least a portion of the customer data may be transformed according to action number into stratified data including strata, with each of the strata representing actions for one or more action numbers. Using a computer, a conditional proportional hazard function may be estimated from a stratum of the stratified data. With the same computer or a different computer, and using the hazard function, likelihoods of a next action may be calculated for individual customers. The likelihoods may be the likelihoods of a next action at a future time by individual customers whose latest action has an action number for which the stratum represents actions. In some examples, a communication may be sent to each of the customers whose calculated likelihood of a next action meets a predefined condition.

An article comprising at least one computer readable storage medium may be provided. The article may contain instructions executable by a computer to perform a method of evaluating probabilities of next actions by customers to permit selective customer targeting. The method may include any combination of steps presented in the preceding paragraph. In some examples, the conditional proportional hazard function may include a baseline hazard function for the stratum and one or more weights for the stratum. Each weight may correspond to a distinct customer attribute, and the conditional proportional hazard function may be a product of (a) the baseline hazard function and (b) a factor incorporating each weight and its corresponding customer attribute.

An apparatus may be provided for evaluating probabilities of next actions by customers using customer data representing a plurality of actions taken by customers with respect to a firm, such as in a non-contractual setting. Each action may be assigned an action number based on when the action was taken by a customer. The apparatus may include at least one storage medium to receive the customer data. The customer data may be stratified, according to action number and using a stratification routine, into strata, with each of the strata representing actions for one or more action numbers. The apparatus may include an estimation routine for estimating a conditional proportional hazard function from a stratum of the customer data. The apparatus also may incorporate a likelihood calculator that calculates, using the hazard function, likelihoods of next actions at one or more times by individual customers whose latest action has an action number for which the stratum represents actions. The apparatus further may include a customer selector that identifies individual customers whose calculated likelihood of a next action meets a predefined condition.

The system disclosed herein may permit a firm to more accurately assess which of its customers are active (“alive”) and which are inactive (“dead” or “churned”). The customers that are active may still be using the firm's products and/or services and thus have potential future value to the firm. In contrast, churned customers interacted with the firm in the past but may have chosen to use the goods and/or services of a competitor of the firm, or may have left the industry altogether, among others. In some cases, a churned customer may bring negative value to the firm through negative comments or flagging the firm's communications as spam. In any event, by assessing the status of its customers, the firm may work more effectively to improve customer retention. The ability to retain a customer adds tremendous value to the firm. For example, reducing churn rate by one percent may add, on average, about five percent to the firm's value. The ability to predict the status of customers now (current status) and also predict their status in any given time window into the future (future status) may be of tremendous value to the firm as it enables the firm to implement retention and loyalty strategies that are proactive instead of reactive. Furthermore, estimating weights of different customer attributes as drivers of customer action and customer churn provide additional insights into which attributes are the key drivers of customer experience and which of the firm's processes and systems need to be improved to ensure an enhanced customer experience.

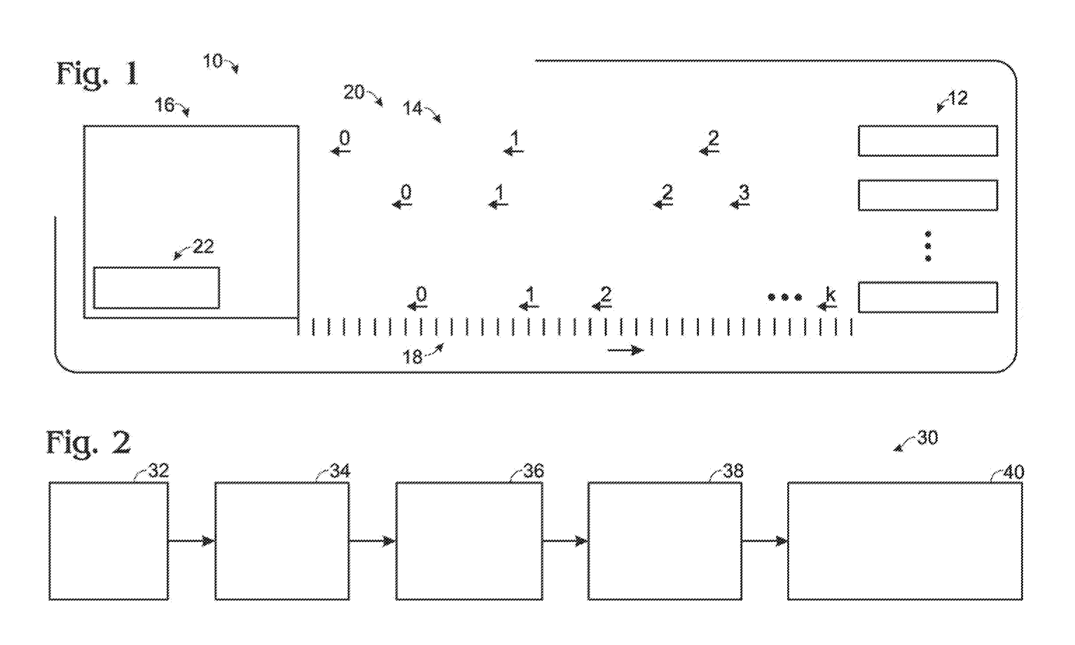

FIG. 1 shows a system 10 for evaluating probabilities of next actions by customers 12 in a non-contractual setting. Customer actions 14 performed with a firm 16 are represented with respect to time 18, to provide customer data 20. Each action for a given customer may be numbered sequentially, to assign an action number according to the order of action occurrence. For example, action numbers may be assigned for each customer starting at zero, which may represent registration of the customer with the firm. A customer may perform any number of actions over a total observation period, such as zero (registration only), one, two (e.g., Customer 1), three (e.g., Customer 2), or more (e.g., Customer N). Also, the actions of each customer may occur independently in time from actions of other customers. The firm may include at least one computer 22 (or a computer network) that logs, stores, and/or receives data about customer actions 14, such as the time (e.g., the date and/or time of day) when each action occurred, the type of each action, a time interval between consecutive actions, and the like. Computer 22 also may calculate, store, and/or receive data regarding customer-specific attributes.

A customer “action,” as used herein, is any type of session, such as a transaction and/or interaction, involving both a customer 12 and firm 16. An action also may be termed an “action session.” The actions available to a customer may be determined by the type of business conducted by the firm. For example, the firm may conduct business over a computer network (e.g., the Internet), such as via one or more websites. Examples of types of customer actions that may be performed over a computer network include registration, a visit (e.g., to a firm website), a download of one or more files, an upload of one or more files, an order and/or purchase of one or more goods and/or services, file viewing, sharing a file(s) (e.g., with another customer), or the like. Examples of types of customer actions that may be performed by a customer physically present at the firm include registration, a purchase of one or more goods/services, a visit, a consultation, a trade, a return of one or more purchased goods/services, or the like.

A “non-contractual setting,” as used herein, is any business arrangement between a firm and customers in which each customer can become inactive at any selected time without notifying the firm and thus without observation by the firm. The term “churn” is used herein to denote attrition, namely, the unobservable (or observable) event of a customer becoming permanently inactive with respect to a firm. In a non-contractual setting, the firm cannot know with certainty whether any given customer that has not performed an action for an extended period of time has actually churned or is just taking a long hiatus from doing business with the firm. The present disclosure provides a measure of the likelihood of customer action at a selected time point after a customer's most recent action and thus offers an indication of customer churn.

A “firm,” as used herein, is any legal or natural person or organized group of people that offers goods and/or services to customers, generally for commercial purposes.

A “customer,” as used herein, is any person or organized group of people that performs actions, such as transactions and/or interactions, with a firm, generally for commercial purposes.

A customer “attribute,” as used herein, is any characteristic of customers. An attribute for an individual customer may be constant or may vary with respect to time and/or customer action number. Example attributes have values and/or may be assigned values for each customer, and may include age, gender, income, occupation, total number of actions, average time interval between actions, a time interval elapsed since the customer's most recent action, number of a particular type of action taken, etc. If the attribute varies over time, a value for the attribute for an individual customer may be determined, such as a value determined after an action has been taken by the customer. An attribute also may be termed a “covariate.”

FIG. 2 shows a flowchart 30 illustrating steps that may be performed by system 10 in an example method of evaluating probabilities of next actions by customers in a non-contractual setting. The steps listed in FIG. 2 may be performed in any suitable order and in any suitable combination, and may be combined with any other steps disclosed elsewhere herein.

Customer data 20 may be received, indicated at 32. The customer data may represent a plurality of actions taken by customers with respect to a firm in a non-contractual setting. The actions for each customer may be associated with a unique customer identifier, may be numbered sequentially, and time intervals between consecutive actions for the customer may be determined. The customer data may be a data sample prepared from a larger collection of customer data by selecting a sample of customers (e.g., a random sample, such as 0.01%) and the action data associated with each customer in the sample.

The customer data may be processed. The action sessions may be organized as intervals with a beginning (from date, from action) and an ending (to date, to action). Action sessions for a customer where actions of the same type (e.g., uploading, ordering, sharing, etc.) occurred within a predefined length of time (e.g., 5, 10, or 30 minutes, among others) may be grouped as only one action session. For example, a customer may upload a set of files, one file at a time, and intuitively the uploading of these files should be grouped as the same action, that is, the same “upload session.”

Each action (or action session) for a customer may be assigned an action-session number, or “action number.” The action number may be an ordinal number that describes the relative temporal position of a particular customer action relative to the entire sequence of actions taken by the client. For example, the initial action for each customer may be registration and may be assigned the number zero. Subsequent first, second, third, etc. actions by the same customer may be numbered, respectively, as 1, 2, 3, and so on. Also, a time interval between consecutive actions for a customer may be determined. After processing, a customer data table may list, for each pair of consecutive actions (i.e., a “from-action” and a “to-action”), any combination of the following: customer identification number, from-action type (e.g., registration), from-action date/time, to-action type (e.g., upload), to-action date/time, duration time (time interval between from-action and to-action), values of attributes for the customer on or at the from-action date/time, and so on. For example, an attribute value may be the cumulative number of uploads from registration to the from-action (including the from-action).

Customer data 20 may be transformed into stratified data composed of a plurality of strata, indicated at 34. The strata may be defined according to the actions numbers for the from-actions and the to-actions represented by each stratum. Each stratum may represent from-data and to-data for one (or more) action number each. For example, observations of from-actions with action number 0 (registration) and to-actions with action number 1 (or no observable to-action with action number 1) for the customers may be grouped into a first stratum, such that the first stratum represents actions assigned action number 0 and transitions (or no transition) to actions assigned action number 1. As an illustration, stratum 1 may represent observations of all customers in the sample where the from-action is registration (action number 0) and the to-action is the first action (action number 1) after registration (e.g., upload, order, share, etc.) or is marked as “EOD” (“end of data,” which is a flag to identify a censored observation if the customer did not take an observable first action after registration). Similarly, stratum 2 may be composed of observations across all customers in the sample where the from-action is assigned action number 1 and the to-action is assigned action number 2 or EOD (for customers that took a first action but not a second action). Some or all of the strata may group action numbers (i.e., may represent from-actions and to-actions for more than one action number each), which may help to accommodate the long tail of the action number distribution produced by individual customers with a large number of actions. For example, stratum 3 may be composed of observations for actions involving transitions from action number 2 to action number 3, and for actions involving transitions from action number 3 to action number 4.

Hazard functions may be estimated from the strata, indicated at 36. A “hazard function,” as used herein, is a probability measure that a customer will have a next action at a given time after a previous action, conditional on the occurrence of the previous action. The hazard function may be based on a Cox conditional proportional hazard model for multiple events (also termed the Model). The Model provides a statistical model in which a baseline hazard probability is rescaled by one or more covariates. The hazard probability may respond exponentially to changes in the value of each covariate. The Model may be semi-parametric, with the hazard baseline function determined as an empirical probability distribution. Alternatively, the Model may be parametric, with the hazard baseline function specified by a theoretical probability distribution.

The Model may be exploited to incorporate the impact of time from the latest action (the “previous action”) and the values of customer attributes along with their weights. The model may estimate the conditional probability of a next action at a time t after the previous action. The outcome of the model for each stratum may be a set of one or more weights for respective corresponding customer attributes and baseline hazard rates at different time points from the previous action (i.e., the time at which the previous action was taken by a customer is time zero). Generally, a distinct hazard function may be estimated for each stratum j with the form

hⱼ(t)=h₀ⱼ(t) exp(βⱼ₁ₓⱼ₁+βⱼ₂ₓⱼ₂+ . . . ),

where h₀ⱼ(t) is the baseline hazard function with respect to time t from the latest customer action (if represented by the stratum), and where each beta) (βⱼ₁, βⱼ₂, . . . ) represents an attribute weight for the stratum and is multiplied by a corresponding customer attribute (xⱼ₁, xⱼ₂, . . . ) for the attribute weight. The attribute may have a customer-specific value defined at the time the stratum data occurred, such as when a customer performed the previous action. Any number of attribute weights and corresponding attributes may be included in the hazard function. Here, two are shown explicitly, but in other examples, one, three, or more weights and corresponding attributes may be utilized. In other words, the baseline hazard function may be scaled using one or more weight values multiplied by their corresponding customer attribute values. Weights may be estimated separately for each stratum. The weights may be estimated using a maximum likelihood method, which may utilize both the uncensored data (from-action and to-action in the stratum) and the censored data (EOD; from-action but not to-action in the stratum).

A likelihood (a probability) of a next action may be calculated from a hazard function for a stratum, indicated at 38. The likelihood may be calculated with a computer and may provide a likelihood of next action at one or more different time points from the latest action taken by individual customers whose latest action has an action number for which the stratum represents actions. The calculation for an individual customer may be performed by selecting a time value (for a time interval beginning at the customer's latest action), obtaining values for weights of the stratum, determining values for attributes of the customer corresponding to each of the weights (at the time the customer completed the latest action), and placing the values into the hazard function to compute a likelihood of next action. In some embodiments, the likelihood of next action may be operated on to provide a probability that expresses a churn-risk score.

A communication may be sent to selected customers based on the likelihoods calculated, indicated at 40. For example, customers with a likelihood of next action that meets a predefined condition may be selected for receiving the communication. The predefined condition may select customers who have a likelihood of next action that is less than a threshold value, so that these customers, who have a higher risk of churning, are targeted. Alternatively, the predefined condition may select customers who have a likelihood of next action that is greater than a threshold value, so that the customers most likely to have churned are excluded. In some embodiments, customers may be selected if their likelihood of next action falls within a predefined range of values. In this case, customers most likely to remain active with the firm (and thus needing no encouragement) and those mostly likely to have churned may be excluded.

The communication may take any suitable form and may be transmitted by any suitable mechanism. Example communications include an e-mail message, a website message, and a pre-printed document. Accordingly, the communication may be sent electronically or may be mailed as a hard-copy document. In some embodiments, the communication may be or include an advertisement, a coupon, a catalog, or any combination thereof.

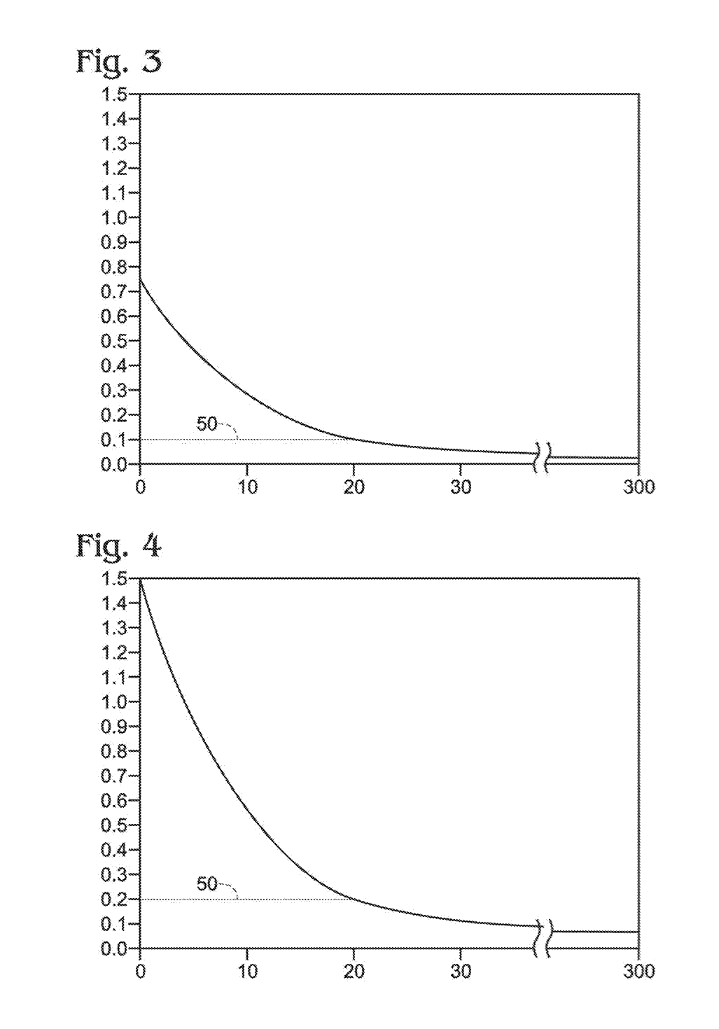

FIGS. 3 and 4 show graphs plotting of an example baseline hazard function for a particular stratum (FIG. 3) and a proportionally adjusted version of the baseline hazard function produced using weighted attribute values for a particular customer (FIG. 4). The time axis represents the time elapsed in days since the previous action (the x-origin of each graph). In this example, the baseline hazard function is scaled by a factor of two at each time point, as illustrated by the changed position of a dashed line 50 in the two figures.

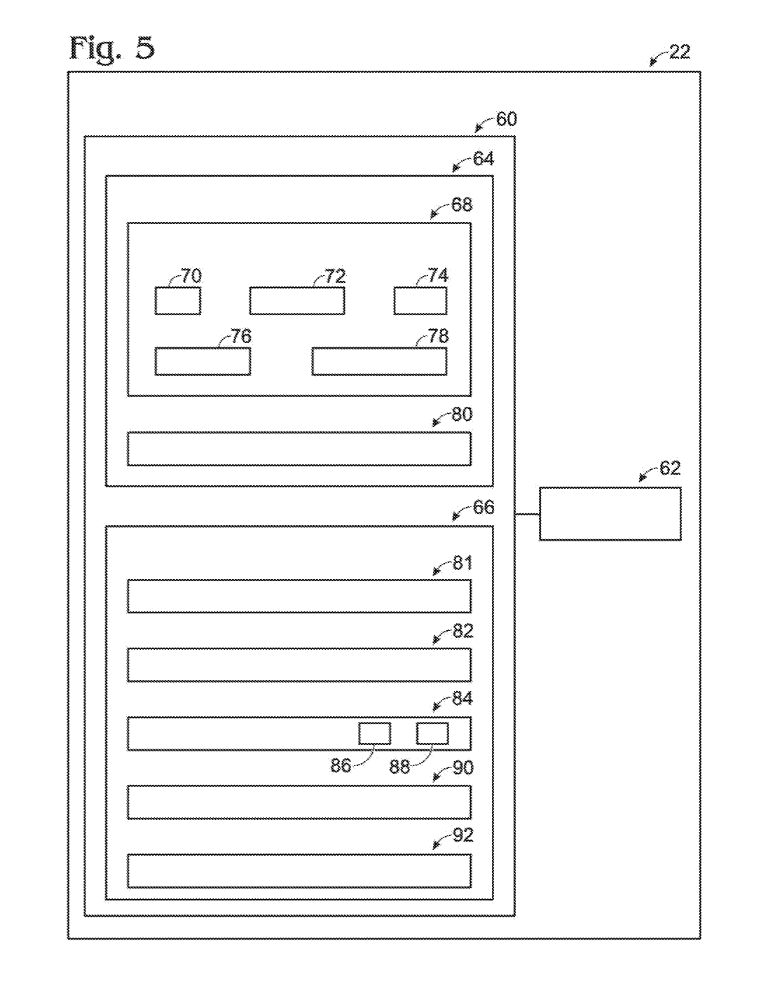

FIG. 5 shows selected aspects of computer 22 of FIG. 1. The computer may include at least one computer readable storage medium, such as memory 60, and a processor 62 operatively connected to memory 60. The storage medium may carry data 64 and instructions 66 for operating on the data.

Data 64 may include customer data 68. The customer data may include customer identifications 70 that uniquely identify each customer and which permit all customer-specific data for each individual customer to be linked. For example, each customer identification may be linked to one or more actions 72, action numbers 74, and times 76 when the actions occurred. The customer identification also may be linked to attributes 78 for the corresponding customer. Data 64 also or alternatively may include customer data that has been transformed into stratified data 80, to promote estimation of hazard functions.

Instructions 66 may include any algorithms to operate on data 64 or derivatives thereof. The instructions may include a data transformation routine 81 that prepares customer data, such as by determining attributes from action data, stratifying the customer data, calculating time intervals between actions for an individual customer, and the like. Instructions 66 also may include a hazard function estimator 82, also termed an estimation routine. The hazard function estimator may be configured to utilize stratified data 80 to produce statistical models for the data, namely, hazard functions 84, which may include baseline hazard functions 86 and weights 88 for each stratum of the stratified data. The instructions further may comprise a likelihood calculator 90 that calculates the likelihood of a next action at different times for individual customers using hazard functions 84. Furthermore, instructions 66 may be equipped with a customer selector 92 that selects customers based on a calculated likelihood of next action for individual customers.

We claim:

1. A method (30) of evaluating probabilities of next actions by customers to permit selective customer targeting, comprising:
receiving (32) customer data (20) representing a plurality of actions (14) taken by customers (12), each action being assigned an action number based on when the action was taken by a customer;
transforming (34) according to action number at least a portion of the customer data (20) into stratified data (80) including strata, each of the strata representing actions for one or more action numbers;
estimating (36), using a computer (22), a conditional proportional hazard function (84) from a stratum of the stratified data (80); and
calculating (38), with a computer using the hazard function (84), likelihoods of a next action at one or more times by individual customers (12) whose latest action has an action number for which the stratum represents actions.

2. The method of claim 1, wherein transforming (34) includes creating a stratum representing data for first actions by customers (12) after their registration with a firm (16) and one or more other strata representing data for subsequent actions by customers.

3. The method of claim 1, wherein estimating (36) includes estimating a respective conditional proportional hazard function (84) for each of a plurality of the strata.

4. The method of claim 1, wherein estimating (36) includes estimating a baseline hazard function (86) for the stratum and one or more weights (88) for the stratum, wherein each weight corresponds to a distinct attribute (78) of the customers (12), and wherein the conditional proportional hazard function (84) is a product of (a) the baseline hazard function (86) and (b) a factor incorporating each weight (88) and its corresponding attribute (78).

5. The method of claim 1, further comprising sending (40) a communication to each of the customers (12) having a calculated likelihood that meets a predefined condition.

6. The method of claim 5, wherein sending (40) a communication includes sending a communication selected from an e-mail message and a pre-printed document.

7. The method of claim 5, wherein sending (40) a communication includes sending a communication to each customer (12) having a calculated likelihood of a next action that is less than a threshold value.

8. The method of claim 1, wherein receiving customer data includes receiving customer data generated in a non-contractual setting.

9. An apparatus (22) for evaluating probabilities of next actions by customers to permit selective customer targeting, comprising:
at least one storage medium (60) to receive customer data (20) representing a plurality of actions (14) taken by customers (12), each action being assigned an action number based on when the action was taken by a customer;
a transformation routine (81) that stratifies the customer data (20) into strata according to action number, with each of the strata representing actions for one or more action numbers;
an estimation routine (82) for estimating a conditional proportional hazard function (84) from a stratum of the stratified data; and
a likelihood calculator (90) that uses the hazard function (84) to calculate likelihoods of a next action at one or more times by individual customers (12) whose latest action (14) has an action number for which the stratum represents data.

10. The apparatus of claim 9, further comprising a customer selector (92) that identifies customers (12) whose calculated likelihoods of a next action meet a predefined condition.

11. The apparatus of claim 9, wherein the estimation routine (82) is configured to estimate a baseline hazard function (86) for the stratum and one or more weights (88) for the stratum, wherein each weight corresponds to a distinct customer attribute (78), and wherein the conditional proportional hazard function (84) is a product of (a) the baseline hazard function (86) and (b) a factor incorporating each weight (88) and its corresponding customer attribute (78).

12. The apparatus of claim 11, wherein the likelihood calculator (90) calculates the likelihoods using values for at least one customer attribute (78) affected by the latest action.

13. An apparatus (22) for evaluating probabilities of next actions by customers using customer data (20) representing a plurality of actions (14) taken by customers (12) with respect to a firm (16), each action being assigned an action number based on when the action was taken by a customer, the customer data (20) being stratified according to action number into strata, with each of the strata representing actions for one or more action numbers, comprising:
an estimation routine (82) for estimating a conditional proportional hazard function (84) from a stratum of the customer data (20);
a likelihood calculator (90) that calculates, using the hazard function (84), likelihoods of a next action at one or more times by individual customers (12) whose latest action has an action number for which the stratum represents actions; and
a customer selector (92) that identifies individual customers (12) whose calculated likelihood of a next action meets a predefined condition.

14. The apparatus of claim 13, wherein the estimation routine (82) is configured to estimate a baseline hazard function (86) for the stratum and one or more weights (88) for the stratum, wherein each weight corresponds to a distinct customer attribute (78), and wherein the conditional proportional hazard function (84) is a product of (a) the baseline hazard function (86) and (b) a factor incorporating each weight (88) and its corresponding customer attribute (78).

15. The apparatus of claim 14, wherein the likelihood calculator (90) calculates the likelihoods using values for at least one customer attribute (78) affected by the latest action.
